(19) United States
(12) Patent Application Publication
(10) Pub. No.: US 2008/0194383 A1
(43) Pub. Date: Aug. 14, 2008

(54) Method for Adapting an Automated Mechanical Transmission Based on a Measured Pto Load

(75) Inventor: Sixten Berglund, Torslanda (SE)

Correspondence Address: WRB-IP LLP, 1217 KING STREET, ALEXANDRIA, VA, 22314, US

(73) Assignee: VOLVO LASTVAGNAR AB, Göteborg (SE)

(21) Appl. No.: 12/063,279

(22) PCT Filed: Sep. 7, 2006
(86) PCT No.: PCT/SE2006/001030

§ 371 Date: Feb. 8, 2008

Related U.S. Application Data
(60) Provisional application No. 60/596,212, filed on Sep. 8, 2005.

(51) Int. Cl. B60K 17/28; B60W 10/06; B60W 10/10

(52) U.S. Cl. 477/97

(57) ABSTRACT

Method for adapting an automated mechanical transmission based upon a PTO load. The method includes setting the transmission gears so that no torque is being transmitted to the output shaft of the transmission. With the PTO load engaged, engine torque is measured by the engine control unit. This torque is compared to the expected engine torque. Using the difference from the expected value and the measured value, the transmission control unit adjusts the shifting of the transmission because the PTO will cause the engine to lose some of its available torque. Based on the PTO load, the transmission control unit will select the appropriate start gear, upshift gears, and downshift gears.

The present application claims the benefit of U.S. Provisional Application No. 60/596,212 filed Sep. 8, 2005. Said application is expressly incorporated herein by reference in its entirety.

### BACKGROUND AND SUMMARY

The present disclosure relates to determining the magnitude of a power take off unit and adapting an automated transmission of a heavy commercial vehicle based on the presence of an additional load of the power take off unit.

Heavy commercial vehicles such as overland trucks and buses are known to employ automatic mechanical transmissions (AMT) that are based on preprogrammed routines. One example of an automatic mechanical transmission is the multi-stage gearbox. A multi-stage gearbox is usually made up of an input shaft, an intermediate shaft, which has at least one gearwheel in engagement with a gearwheel on the input shaft, and a main shaft with gearwheels which engage with gearwheels on the intermediate shaft. The main shaft is also connected to an output shaft coupled to the driving wheels via, for example, a drive shaft. Each pair of gearwheels has a different ratio compared with another pair of gearwheels in the gearbox. Different gears are obtained by virtue of different pairs of gearwheels transmitting the torque from the engine to the driving wheels.

One of the problems in controlling an AMT, however, is attributable to the power consumption by a power take off (PTO). A PTO can generally be classified as a PTO upstream or downstream of the master clutch. In general, a PTO that is upstream of the master clutch can take power from, the vehicle's engine regardless of the state of engagement of the transmission via the master clutch. A PTO that is located downstream of the master clutch is typically used when the vehicle is stationary. A downstream PTO often involves placing the gearbox in neutral so that the vehicle wheels are not drivingly engaged to the transmission. However, there are cases when a transmission mounted PTO is used while the vehicle is in motion. PTO's are known to impose significant load on Ihe vehicle's engine. Exemplary PTOs use engine power to drive hydraulic pumps that can be activated for such things as mixing applications (concrete trucks) or causing motion of a bed on the truck such as in the case of dump trucks and flat-bed haulers.

Similarly, PTOs may be used to power spreaders such as those used to broadcast salt or sand on icy roads, or to power associated trailer components such as compartment refrigeration units. While these examples are not exhaustive, they do serve to exemplify PTO loads of significant magnitude which can appreciably compromise the driving power available from the engine of the vehicle for the drive wheels, and which often causes undesirable disturbances to automated transmission programs that do not take then-intermittent influences into account. For purposes of comparison, these significant PTO loads can be compared to less influential engine loads imposed by such power consumers as cooling fans and air conditioning compressors. As an example of the potential drag that a PTO can impose on the vehicle's engine, it is not uncommon for PTOs to siphon off engine torque on the order of 5 to 3000 Nm. An example of a PTO that requires on the order of 3000 Nm is a fire truck that operates a water pump, and an example of a PTO that requires on the order of 5 Nm is a PTO for a small refrigerator device.

The present invention appreciates the fact that transmission control routines that do not take into consideration whether or not a significant PTO load is imposed on the vehicle's engine will experience degradation in performance when the PTOs are operational. For example, if the PTO loads are of such magnitude that the engine can not compensate therefore by increased engine speed, there will be an effective reduction in power available for driving the vehicle. The strategy must, however, appreciate that the behavior of the PTO-loaded engine is not that of a smaller engine, but is in fact a unique behavior of the particular engine whose power is divided between a PTO of significant load and the drivetrain.

Still further, it has been appreciated that it can be difficult to detect a PTO's influence on an engine if it is also connected to a loaded drivetrain; therefore, one of the aspects of the present invention has as a goal to provide a solution wherein drivetrain loads do not conflict with PTO detection procedures.

In at least one embodiment, the present invention takes the form of a method of sensing the magnitude of a PTO load. The method comprises (includes, but is not necessarily limited to) measuring the PTO load while the engine is operating at a substantially constant engine speed and the driveline is disengaged. The disengagement of the driveline, preferably disengages the drivewheels from receiving torque. Then, the reduction of available torque is sensed as compared to an engine without a PTO load. This reduction in torque results in less available engine torque for transmission to the drivewheels.

In another embodiment, a semi-automatic transmission is adjusted based upon the magnitude of the additional load placed on the engine by a PTO. The transmission controller is adjusted to account for the loss of torque to the PTO. Transmission control can be classified by two different types of control, namely gear shifting and gear selection. Gear shifting describes the actual engagement of the mechanical elements of the transmission. For example, gear shifting is the process of actually moving the mechanical parts of the transmission in the proper order to engage or disengage a gear or otherwise manipulate the transmission in response to a given request or instruction. Gear selection is the process of selecting the desired gear or decision to maintain the current gear state. Furthermore, gear selection can consider various parameters in order to determine the proper gear to engage. In an automated transmission, transmission control is carried out by having a gear selection strategy used to determine what gear should be engaged, then implementing a gear shifting strategy that actually carries out the requested shift in the transmission.

In a preferred embodiment, the transmission is placed into a neutral gear state to estimate the PTO load on the engine.

In yet another embodiment, the PTO unit load is determined by operating a prime mover at a substantially constant speed and disengaging the driveline so that substantially no torque is supplied to the drivewheels of the heavy vehicle. Furthermore, it determines the torque magnitude indicative of a power take off unit's torque consumption.

### BRIEF DESCRIPTION OF THE DRAWINGS

The present disclosure will now be more fully described, by way of example, with reference to the accompanying drawings in which:

FIG. 1 is a flow diagram illustrating one method for determining the magnitude of the PTO torque load; and

FIG. 2 is a schematic diagram of a power train of a heavy vehicle and controls associated therewith.

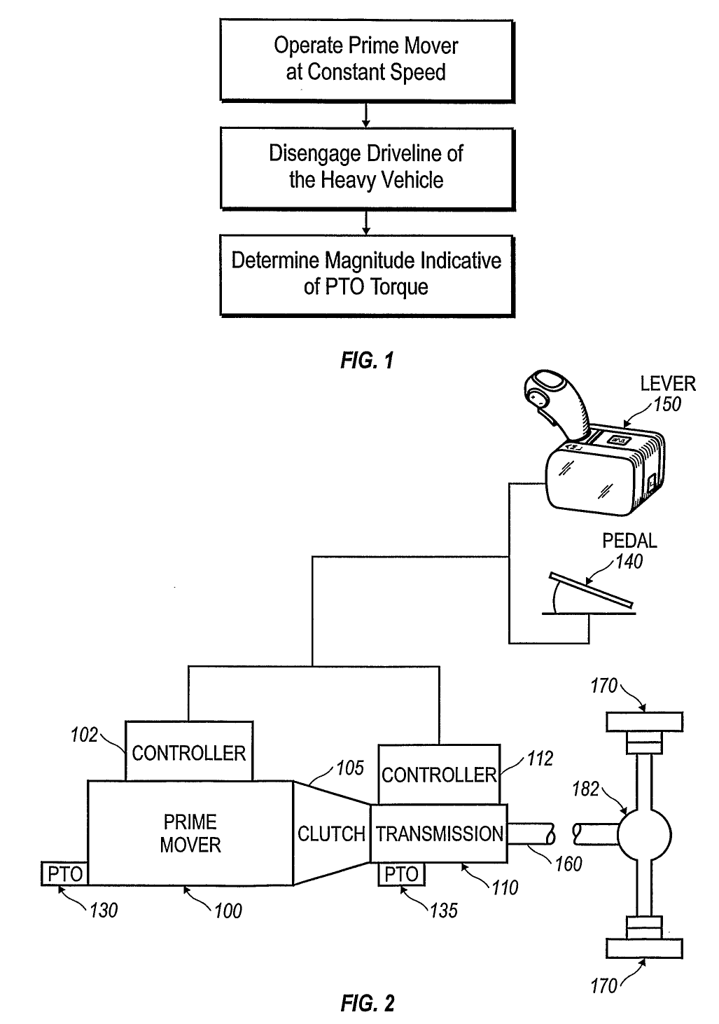

### DETAILED DESCRIPTION

One preferred embodiment relates to detecting a PTO load while the engine speed is substantially constant and the driveline disengaged. Another embodiment adapts vehicle systems in response to the determined torque magnitude (torque draw) of the PTO load, including making adjustments to the shifting strategies of an automatic mechanical transmission. Other vehicle systems include the engine brake, prime mover, and service brakes.

FIG. 2 illustrates a block diagram showing the typical interconnections in an automated mechanical transmission system between engine controller 102, transmission controller 112, shifting lever 150, and accelerator pedal 140. Although not required, when the prime mover 100, typically an internal combustion engine 100, and the transmission 110 are both controlled through electronic controllers 102, 112. Information can be shared between these controllers 102, 112. This can lead to efficient exchange of engine information to the transmission 110 and transmission information to the engine 100. Even though the transmission controller 112 and engine controller 102 are shown separately, it is contemplated that the controllers can be combined in a single unit. Alternatively, the engine controller 102 and transmission controller 112 can be made of sub-controllers, for example the transmission controller 112 might have controllers specifically designed to control the gear shifting and gear selection for the transmission 110.

The gear selector/lever 150 enables the driver to select an appropriate driving mode. The driving modes include but are not limited to automatic, manual, and low. Furthermore, in manual mode the driver can request specific shifting of gears using the gear selector 150, preferably through the use of buttons to increase or decrease the gear ratio. As described above, a PTO can be a PTO 130 located upstream of the master clutch 105 or a PTO 135 located downstream of the master clutch 105. The master clutch 105 transfers energy to the transmission 110, which further transfers the energy to the driveshaft 160. Then, a rear gear or differential 182, transfers energy to the drivewheels 170.

A PTO 130, 135, when operationing, constitutes a prime mover power consumer that should be considered in order to make automated transmission shifting more comfortable, efficient, faster, and to appropriate gear ratios. In order to take into account the additional load of the PTO 130, 135, it is necessary to calculate or otherwise quantify the load. This can be performed either using conventional sensors onboard a given vehicle or through specifically designed sensors. Some of the standard sensors include the input shaft speed sensor, engine speed sensor, and output shaft speed sensor. The prime mover control unit 102 preferably produces or calculates a value of the prime mover's 100 generated torque. Alternatively, the torque that is being produced by the prime mover 100 is calculated by the prime mover control unit 102. While there are many ways of calculating this prime mover 100 generated value or measured torque magnitude, a few examples involve using the dwell angle of injection into a diesel engine and using current readings in an electric motor where the prime mover is a diesel engine or electric motor, respectively. The prime mover 100 can be any device designed to provide power to the drivetrain of the heavy vehicle. The prime mover 100 can be one of a diesel engine, gasoline engine, other internal combustion engine, an electric motor, or a hybrid engine.

The measurement of PTO load involves placing the transmission 110 in a configuration in which no torque is being transmitted to the output shaft of the transmission 110. It should be appreciated that the torque transmitted to the output shaft may not be exactly zero, but the amount transferred during measurement should be so small as to be negligible. There are several configurations for assuring that no torque is transmitted to the output shaft of the transmission 110 (to the drive or propeller shaft). One way is to have the clutch 105 disengaged so that no torque is transmitted to the input shaft of the transmission 110. Another method involves placing the transmission 110 in neutral so that no torque is transmitted to the output shaft of the transmission 110. Alternatively, the main shaft may be disengaged preventing torque from being transferred to the output shaft despite engagement of the countershaft. In order to measure a PTO load located downstream of the clutch 105, an appropriate procedure must be selected from above to allow the PTO 135 to remain engaged, but supply substantially no torque to the drivewheels 170. Furthermore, if the PTO 130, 135 is equipped with a specially designed switch and the load of the attached PTO 130, 135 is known, the activation of the switch can be used to determine the magnitude of the PTO's 130, 135 torque consumption.

The measurement of the PTO load further involves having the prime mover 100 maintain a substantially constant speed. This speed hi a preferred embodiment is the idling speed of the prime mover 100. Other points at which speed is substantially constant are possible as well and remain within the scope of this disclosure. For instance, while the driveline is disengaged the vehicle operator depresses the accelerator pedal 140 to provide additional torque to the PTO 130, 135 so that the PTO 130, 135 will operate more efficiently. During this process, the vehicle operator may maintain the prime mover 100 at a substantially constant, but elevated speed. In yet another embodiment, the prime mover 100 is maintained at a constant speed, when the driveline is disengaged while rolling down a grade such that the vehicle freewheels. In a still further embodiment, the prime mover 100 is operated at a speed greater than idle speed to properly power an additional PTO 130, 135 such as an air compressor or hydraulic pump. While these examples have been provided, they are intended to describe types of additional loads that require the prime mover 100 to be operated at a substantially higher speed than idle speed. The measurement of PTO load further requires that the driveline be disengaged in a fashion as described above. Similarly, the driver may maintain the prime mover 100 at or near constant speed while the PTO load is being quantified.

Assessment of the PTO load is important because it is used when configuring shifts as the vehicle is driven; in this manner, the transmission 110 is permitted to appropriately compensate for the loss of prime mover 100 torque due to the PTO load. The sensitive driving conditions of the vehicle include take off, reversing, slow movement, road speeds, and highway speeds. These conditions exist anytime a gear of the vehicle is selected and motion is caused through the transmission 110. Furthermore, the transmission controller 112 is adjusted to account for the loss of torque to the PTO 130, 135. Transmission control can be classified by two different types of control, namely gear shifting and gear selection. Gear shifting describes the actual engagement of the mechanical elements of the transmission 110. For example, gear shifting is the process of actually moving the mechanical parts of the transmission 110 in the proper order to engage or disengage a gear or otherwise manipulate the transmission 110 in response to a given request or instruction. Gear selection is the process of selecting the desired gear or decision to maintain the current gear state. Furthermore, gear selection can consider various parameters in order to determine the proper gear selection. In an automated transmission 110, transmission control is carried out by having a gear selection strategy used to determine what the gear should be, then implementing a gear shifting strategy that actually carries out the requested shift in the transmission 100.

While preferred embodiments of the presently disclosed solutions have been shown and described herein, it will be obvious that such embodiments are provided by way of example only. Numerous variations, changes and substitutions will occur to those skilled in the art without departing from the disclosure herein. Accordingly, it is intended that the embodiments claimed be limited only by the spirit and scope of the claims.

1. A method for adjusting transmission shifting of a heavy vehicle comprising:
sensing a PTO loaded condition of an engine of the vehicle when no torque is being delivered to the drivewheels and the engine is running at a substantially constant engine speed; and
adjusting operation of the transmission in consideration of the reduced torque available for application to an output shaft of the transmission under driving conditions.

2. A method for sensing a power take off load on an engine of a heavy vehicle with an automatic mechanical transmission comprising:
operating the engine at a substantially constant speed;
disengaging a driveline of the heavy vehicle so that substantially no torque is supplied to drivewheels of the heavy vehicle; and
sensing the magnitude of the power take offload by comparing a value of measured torque to a computed value of engine generated torque.

3. The method of sensing a power take offload of claim 2, wherein the automatic mechanical transmission is adjusted in response to the measured torque.

4. A method for determining a power take off unit load on a prime mover of a heavy vehicle with an automatic mechanical transmission comprising:
operating a prime mover at a substantially constant speed;
disengaging a driveline of the heavy vehicle so that substantially no torque is supplied to drivewheels of the heavy vehicle; and
determining a torque magnitude indicative of a power take off unit's torque consumption.

5. The method for determining a power take off unit load as recited in claim 4, wherein the determining the torque magnitude is performed by measuring the torque magnitude of the power take off unit.

6. The method for determining a power take off unit load as recited in claim 5, wherein the measurement of the torque magnitude of the power take off unit is measured using a torque sensor.

7. The method for determining a power take off unit load as recited in claim 5, wherein the measurement of the torque magnitude is based at least in part on a computation that considers the dwell angle of injection.

8. The method for determining a power take off unit load as recited in claim 5, wherein the measurement of the torque magnitude of the power take off unit is measured using information supplied by a control unit.

9. The method for determining a power take off unit load as recited in claim 8, wherein the control unit is an engine control unit.

10. The method for determining a power take off unit load as recited in claim 5, wherein the measurement of the torque magnitude of the power take off unit requires activation of a power take off switch.

11. The method for determining a power take off unit load as recited in claim 4, comprising adapting vehicle systems in response to the determined torque magnitude.

12. The method for determining a power take off unit load as recited in claim 11, wherein one of the vehicle systems is an automatic mechanical transmission.

13. The method for determining a power take off unit load as recited in claim 12, comprising adapting gear shifting of the automatic mechanical transmission using the torque magnitude of the determined power take off unit load.

14. The method for determining a power take off unit load as recited in claim 12, comprising adapting gear selection of the automatic mechanical transmission using the torque magnitude of the determined power take off unit load.

15. The method for determining a power take off unit load as recited in claim 4, wherein the prime mover is one of a diesel engine, a gasoline engine, an electric engine, and a hybrid engine.
